(19) United States
(12) Patent Application Publication
(10) Pub. No.: US 2006/0179459 A1
(43) Pub. Date: Aug. 10, 2006

(54) Signal processing apparatus and recording method

(75) Inventor: Norikatsu Chiba, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/290,785

(22) Filed: Dec. 1, 2005

(30) Foreign Application Priority Data
Feb. 4, 2005 (JP) 2005-028947

(51) Int. Cl. H04N 7/173; H04N 5/91; H04N 7/18; H04N 7/08; H04N 7/06; H04N 7/52

(52) U.S. Cl. 725/80; 725/78; 386/100; 725/89

(57) ABSTRACT

A signal processing apparatus includes a determining unit which determines a kind of moving picture data of a recording object, an acquiring unit which acquires from outside an encoding parameter corresponding to the kind of the moving picture data of the recording object determined by the determining unit, an encoding unit which executes an encoding process of encoding the moving picture data of the recording object in accordance with the encoding parameter acquired by the acquiring unit, and a storing unit which stores in a storage medium the moving picture data encoded by the encoding unit.

### CROSS-REFERENCE TO RELATED APPLICATIONS

This application is based upon and claims the benefit of priority from prior Japanese Patent Application No. 2005-028947, filed Feb. 4, 2005, the entire contents of which are incorporated herein by reference.

### BACKGROUND OF THE INVENTION

1. Field of the Invention

The present invention relates to a signal processing apparatus capable of recording moving picture data and a recording method for use in the device.

2. Description of the Related Art

In recent years, various recording devices have been developed which can record and reproduce broadcasting program data such as a TV program. In such a recording device, the broadcasting program data is encoded in a moving picture encoding system such as a moving picture encoding expert group (MPEG) and thereafter stored in storage medium. Furthermore, the broadcasting program data of a recording object can be designated using an electronic program table such as an electric program guide (EPG) or an internet electric program guide (iEPG).

In Jpn. Pat. Appln. KOKAI Publication No. 2001-326875, a television receiver is disclosed which receives digital TV broadcasting. This television receiver has a function of changing a display control parameter such as brightness or sharpness in accordance with a category of the program in a case where the received broadcast program is displayed. Accordingly, the received broadcast program can be displayed with a satisfactory picture quality.

However, in the recording device, it is important to record moving picture data with a high picture quality rather than to adjust a picture quality at a displaying time. At the recording time, it is necessary to encode the moving picture data as described above. Usually in this encoding, a common encoding parameter is used in a case where broadcasting program data is recorded.

However, an optimum encoding parameter essentially differs with a kind of moving picture data. For example, in an animation video in which color rapidly changes and there are many high-frequency components as compared with a drama of live-action video, it is preferable to record even components having high frequencies unlike the live-action video. Therefore, recording cannot be performed with a satisfactory picture quality for some kinds of the moving picture data of the recording object in some case.

Therefore, there is a demand for a signal processing apparatus and a recording method in which the moving picture data can be recorded with a sufficiently satisfactory picture quality.

### BRIEF SUMMARY OF THE INVENTION

According to one aspect of the present invention, there is provided a signal processing apparatus comprising a determining unit which determines a kind of moving picture data of a recording object, an acquiring unit which acquires from outside an encoding parameter corresponding to the kind of the moving picture data of the recording object determined by the determining unit, an encoding unit which executes an encoding process of encoding the moving picture data of the recording object in accordance with the encoding parameter acquired by the acquiring unit, and a storing unit which stores in a storage medium the moving picture data encoded by the encoding unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of a network system using a signal processing apparatus according to a first embodiment of this invention;

FIG. 2 is a block diagram showing an example of a system constitution of the signal processing apparatus of FIG. 1;

FIG. 3 is a flowchart showing a recording control processing executed by the signal processing apparatus of FIG. 1;

FIG. 4 is a diagram showing an example of a category selection screen for use in the signal processing apparatus of FIG. 1;

FIG. 5 is a diagram showing an example of a encoding parameter for use in the signal processing apparatus of FIG. 1;

FIG. 6 is an explanatory view of another example of the encoding parameter for use in the signal processing apparatus of FIG. 1;

FIG. 7 is a flowchart showing another example of the recording control executed by the signal processing apparatus of FIG. 1; and

FIG. 8 is a flowchart showing an example of a specific procedure of the recording control executed by the signal processing apparatus of FIG. 1.

### DETAILED DESCRIPTION OF THE INVENTION

Embodiments of the present invention will be described hereinafter with reference to the drawings.

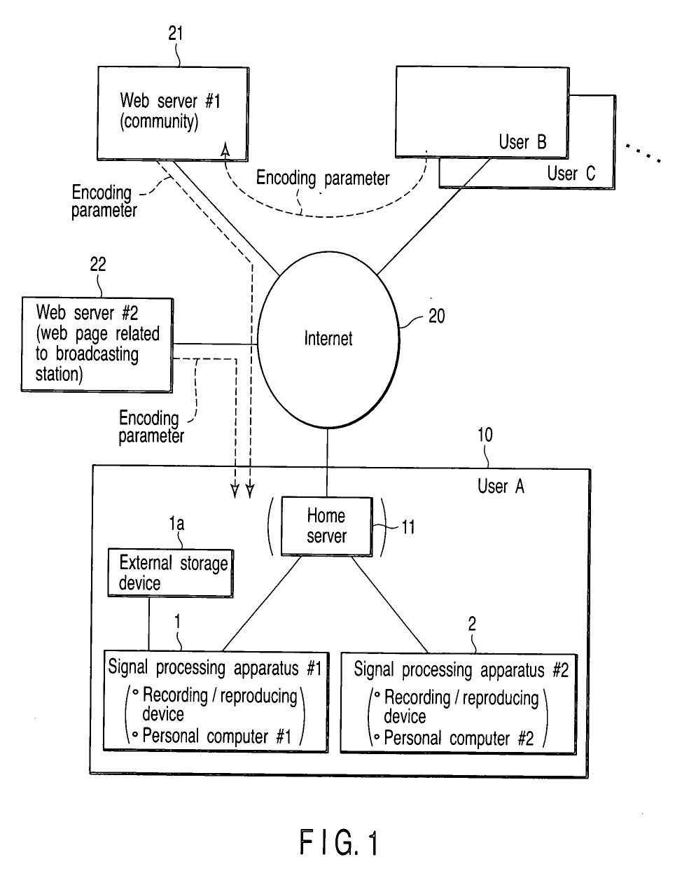

FIG. 1 shows an example of a network system using a signal processing apparatus according to one embodiment of the present invention. A home network system 10 installed in user A's home is provided with two signal processing apparatuses 1, 2 and a home server 11. Each of these signal processing apparatuses 1, 2 has a function of recording and reproducing moving picture data such as broadcasting program data. Each of these signal processing apparatuses 1, 2 is realized, for example, by a recording/reproducing device, a personal computer, a function extended board and the like. Each of these signal processing apparatuses 1, 2 has a function of automatically acquiring a encoding parameter corresponding to a kind of the moving picture data of a recording object from an outside (e.g., a web site on an internet 20, an external apparatus connected to the signal processing apparatuses 1, 2, or broadcasting data, sideband data, etc.). In case of broadcasting program data, the kind of the moving picture data basically means a category (e.g., drama, movie, animation, news, sports, etc.). Alternatively, the kind is not limited to the category, and means a group or a unit in which different settings are desirable in encoding a moving picture. As to the moving picture data obtained in performed photographing by use of a video camera, the kind of the moving picture data means, for example, a photographed object (e.g., an athletic festival, a concert, etc.).

The signal processing apparatuses 1, 2 are connected to the home server 11 via a home network constituted by a cable or radio local area network (LAN). The home server 11 is a communication device for connecting the signal processing apparatuses 1, 2 to the Internet 20, and functions as a router. Alternatively, the signal processing apparatuses 1, 2 may be directly connected to the network such as the Internet without interposing the home server 11.

Each of the processing control apparatuses 1, 2 can access web servers 21, 22 and the like on the Internet 20 via the home server 11 or directly without interposing the home server 11. The web server 21 is a server which operates a community. Each user can submit/browse various information to the community. In the present embodiment, a plurality of types of encoding parameters corresponding to the respective kinds of various moving picture data are stored in the web server (hereinafter referred to as a community server) 21. An arbitrary user (user A, B, C, . . . ) can upload and download the encoding parameter with respect to the web server 21. Accordingly, a plurality of types of encoding parameters corresponding to various types of moving picture data can be shared among a plurality of users A, B, C, . . . . In the web server 21, uploaded encoding parameters are rated, for example, depending on popularity determined by the number of times of downloading of the encoding parameter, an authority degree determined by an authority level of the user who has uploaded the encoding parameter, a date when the encoding parameter was uploaded and the like.

The web server 22 is a server which presents a web page presented, for example, by a broadcasting station or the like. Also in this web server 22, there are stored a plurality of types of encoding parameters corresponding to the respective kinds of various broadcasting program data.

Each of the signal processing apparatuses 1, 2 automatically acquires the encoding parameter corresponding to the kind of the broadcasting program data of the recording object from the broadcasting data or the sideband data, or the web server 21 or the web server 22 of the broadcasting station, and encodes the broadcasting program data of the recording object in accordance with the acquired encoding parameter. Accordingly, the broadcasting program data of the recording object can be encoded using the encoding parameter suitable for a content of the broadcasting program data. The encoded broadcasting program data is stored in storage medium (hard disk, digital versatile disc (DVD), etc.) disposed in the signal processing apparatuses 1, 2, or an external storage device la connectable to the signal processing apparatus 1 or the like. The external storage device la is connected to the signal processing apparatus 1, for example, via a universal serial bus (USB) or a network.

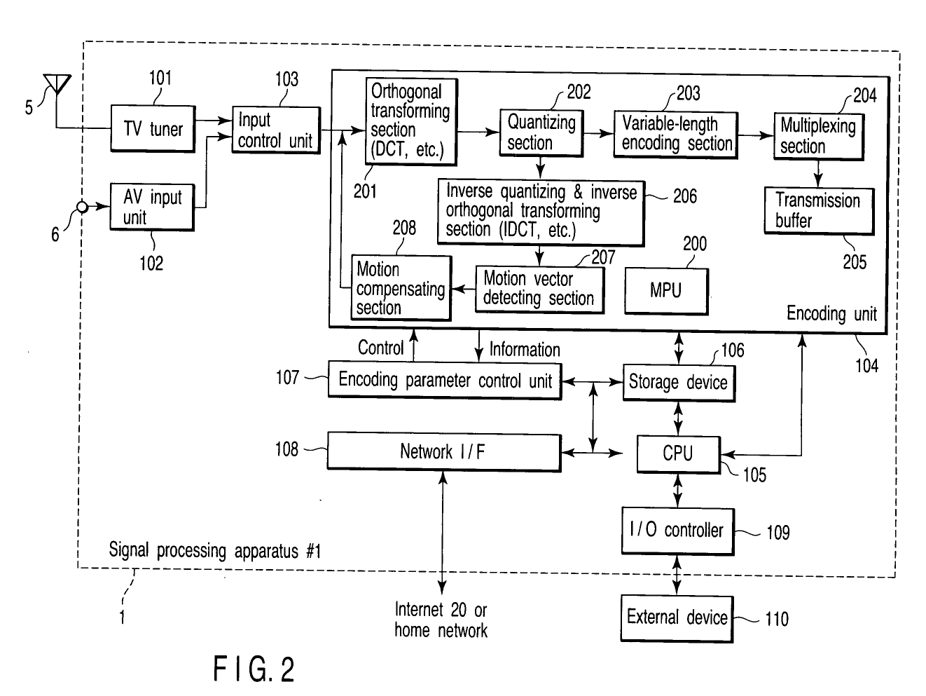

Next, a configuration example of the signal processing apparatus 1 will be described with reference to FIG. 2.

This signal processing apparatus 1 is provided with a TV tuner 101, an audio video (AV) input unit 102, an input control unit 103, a encoding unit 104, a CPU 105, a storage device 106, a encoding parameter control unit 107, a network interface 108, an I/O controller 109 and the like.

The TV tuner 101 is connected to an antenna 5. This TV tuner 101 is a broadcasting receiving unit which receives broadcasting data of a target channel via the antenna 5. The broadcasting program data presented by the broadcasting data received by the TV tuner 101 is sent to the input control unit 103.

The AV input unit 102 inputs the moving picture data transmitted from the external apparatus (a video camera, a video cassette recorder (VCR), an external tuber, an apparatus which generates the moving picture data, such as a moving picture reproducing apparatus, etc.) via an input terminal 6. The moving picture data input from the external apparatus by the AV input unit 102 is sent to the input control unit 103.

The input control unit 103 transmits to the encoding unit 104 either of the moving picture data included in the broadcasting program data input from the TV tuner 101 and the moving picture data input from the AV input unit 102.

The encoding unit 104 executes encoding processing by a fixed-rate or variable-rate moving picture encoding system such as MPEG2 or MPEG4. In this encoding processing, the moving picture data input from the input control unit 103 is encoded (compression-encoded) in accordance with the encoding parameter set to the encoding unit 104. This encoding processing includes a plurality of processing steps of motion vector detection, motion compensation (motion estimation), orthogonal transformation, quantization, inverse quantization, inverse orthogonal transformation, variable-length encoding and the like. The encoding parameter includes a plurality of control values to control these encoding steps.

For example, the encoding parameter includes a combination of: (1) the control value indicating a kind [discrete cosine transform (DCT), Discrete Hadamard transformation (DHT), etc.] of the orthogonal transformation, (2) the control value be associated with the quantization to designate a quantiser scale, a quantiser matrix or the like, (3) the control value to designate a motion vector searching region, a searching method, or a searching precision, (4) the control value to designate a round-down level be associated with an error signal between a predicted image and an input image, (5) the control value be associated with a variable-length encoding method such as Huffman encoding or arithmetic encoding or the control value to designate a scanning direction of an orthogonal transformation coefficient group, when executed variable-length encoding, (6) the control value of a encoding method such as an intraframe encoding or inter-frame encoding and the like.

As shown in FIG. 2, the encoding unit 104 includes a micro processing unit (MPU) 200, an orthogonal transforming section 201, a quantizing section 202, a variable-length encoding section 203, a multiplexing section 204, a transmission buffer 205, an inverse quantizing & inverse orthogonal transforming section 206, a motion vector detecting section 207, a motion compensating section 208 and the like.

The MPU 200 controls each component of the encoding unit 104. The orthogonal transforming section 201 orthogonally transforms an error signal between input moving picture data and predicted image data obtained by the motion compensating section 208 for every predetermined block by use of an orthogonal transformation system designated by the control value be associated with the orthogonal transformation. The quantizing section 202 quantizes the orthogonal transformation coefficient group in each block based on the control value be associated with the quantization which designates the quantization scale or matrix. The inverse quantizing & inverse orthogonal transforming section 206 executes processing which is inverse to the processing of each of the quantizing section 202 and the orthogonal transforming section 201, and generates a reference image. The motion vector detecting section 207 executes motion estimation based on the control values which designates the motion vector searching region, the searching method, or the searching precision to thereby detect the motion vector for every block of the reference image. The motion compensating section 208 generates the predicted image data by use of the motion vector and the reference image, and rounds the error signal between the input moving picture data and the predicted image data in accordance with the control value which designates the round-down level to thereby calculate the error signal to be actually supplied to the orthogonal transforming section 201.

The variable-length encoding section 203 executes scanning in order to rearrange a two-dimensional orthogonal transformation coefficient group into a one-dimensional orthogonal transformation coefficient group according to the control value which designates the scanning direction, and variable-length encodes the one-dimensional orthogonal transformation coefficient group based on the control value of the encoding method. The multiplexing section 204 multiplexes the variable-length-encoded orthogonal transformation coefficient group, motion vector information and the like. A moving picture stream obtained by the multiplexing section 204 is sent to the storage device 106 via the transmission buffer 205, and stored in the storage device 106.

The storage device 106 is constituted by, for example, a hard disk drive which records data in magnetic disk medium, a digital versatile disc (DVD) drive which records data in optical disc medium and the like. Several encoding parameters acquired from the outside are also stored in the storage device 106. Furthermore, a standard encoding parameter is also stored in the storage device 106. The standard encoding parameter is a encoding parameter for use in a case where the encoding parameter corresponding to the moving picture data of the recording object cannot be acquired from the outside.

The CPU 105 is a processor disposed in order to control an operation of the signal processing apparatus 1. The CPU 105 executes processing to determine the kind of the moving picture data of the recording object, and processing to acquire from the outside the encoding parameter corresponding to the kind of the moving picture data. Furthermore, the CPU 105 also has a function of analyzing a encoded data string of the moving picture data encoded using the standard encoding parameter, and preparing a new encoding parameter suitable for the moving picture data. To record the moving picture data in which the new encoding parameter is prepared by the learning function again, the encoding is executed using the encoding parameter prepared by the learning function, not using the standard encoding parameter.

The encoding parameter control unit 107 sets the encoding parameter corresponding to the kind of the moving picture data of the recording object with respect to the encoding unit 104 under the control of the CPU 105. In this case, a plurality of control values included in the encoding parameter are each set to the corresponding component in the encoding unit 104, respectively.

The network interface 108 executes communication with the home server 11 or the signal processing apparatus 2 via the home network or communication with the web servers 21, 22 via the home network or the Internet 20 under the control of the CPU 105.

The I/O controller 109 executes communication with an external device 110 under the control of the CPU 105. The external device 110 is constituted by, for example, a memory card, a USB memory or the like.

The signal processing apparatus 2 described with reference to FIG. 1 has the same constitution as that of the signal processing apparatus 1.

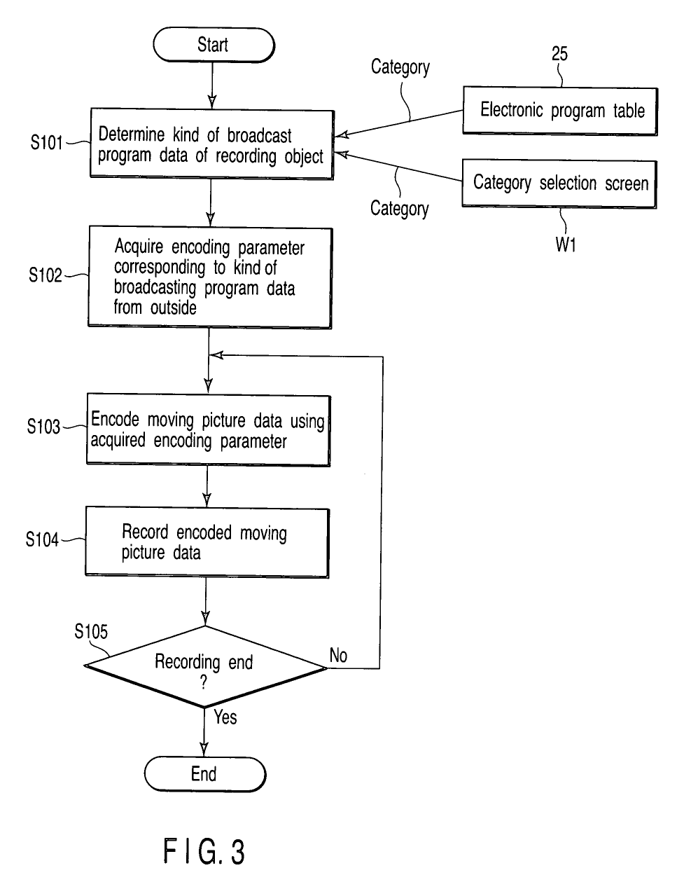

Next, a recording control processing executed by the CPU 105 will be described with reference to a flowchart of FIG. 3. Here, there is assumed a case where the broadcasting program data is recorded.

The broadcasting program data of the recording object is usually designated using an electronic program table 25 such as an electric program guide (EPG) or an internet electric program guide (iEPG). The electronic program table 25 is electronic program table information on each broadcasting program data presented by the broadcasting data. In the electronic program table 25, there are described a program name, a category (drama, movie, animation, sports program, news, etc.), a broadcasting start time, a broadcasting end time and the like for every broadcast program of each channel. When the user designates the broadcasting program data of the recording object from programs described in the electronic program table 25, the CPU 105 starts recording the designated broadcasting program data, or reserves the recording of the designated broadcasting program data. In this case, the CPU 105 acquires the category of the broadcasting program data designated as the recording object with reference to the electronic program table 25 to thereby determine the kind of the broadcasting program data (step S101).

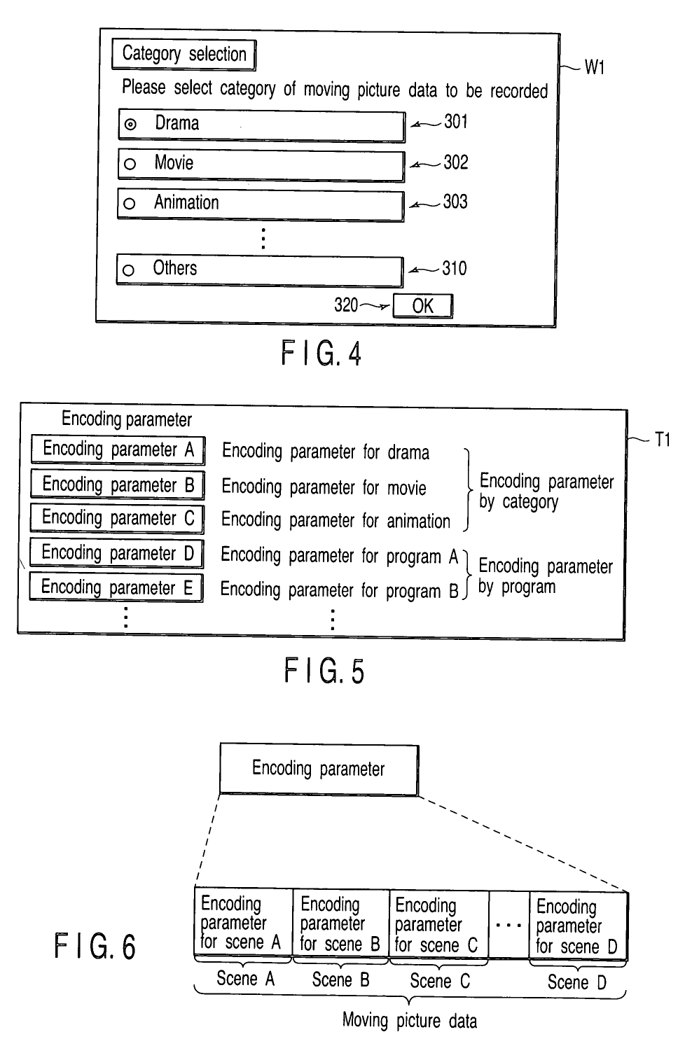

Moreover, in the step S101, the CPU 105 may allow the user to designate the kind of the broadcasting program data of the recording object by use of a category selection screen W1 shown in FIG. 4. This category selection screen W1 is an operation screen for the user to designate the kind of the broadcasting program data of the recording object. In the category selection screen W1, there is disposed a group of radio buttons 301 to 310 which correspond to a plurality of categories such as drama, movie, and animation. When a user presses a determination button 320, the CPU 105 determines the category corresponding to the presently selected radio button as the kind of the broadcasting program data of the recording object. Alternatively, the user may be allowed to input a keyword, thereby displaying associated categories, and to select the category from them.

Next, the CPU 105 executes processing to acquire from the outside the encoding parameter corresponding to the kind of the broadcasting program data of the recording object (step S102). In this step S102, the CPU 105 acquires the encoding parameter corresponding to the kind of the broadcasting program data of the recording object from the broadcasting data or the sideband data, or from the web server 21, the web server 22 of the broadcasting station, the external device 110, the external storage device 1a, the signal processing apparatus 2 or the like. For example, in the web server 21, the web server 22 of the broadcasting station and the like, a plurality of encoding parameters corresponding to the respective kinds of the broadcasting program data are managed by a encoding parameter table T1 shown in FIG. 5. In this encoding parameter table T1, there are registered, for example, a group of encoding parameters (encoding parameters A, B, and C) suitable for the respective categories, and a group of encoding parameters (encoding parameters D, E, . . . ) suitable for several specific programs. The CPU 105 searches the encoding parameter table T1 by use of a category name, a program name or the like corresponding to the broadcasting program data of the recording object, and thereby acquires from the encoding parameter table T1 the encoding parameter corresponding to the kind of the broadcasting program data of the recording object, that is, the encoding parameter suitable for a content of the broadcasting program data of the recording object. The acquired encoding parameter is stored, for example, in the storage device 106.

Next, the CPU 105 controls the encoding parameter control unit 107, and sets to the encoding parameter control unit 107 the encoding parameter acquired from the outside. Accordingly, the encoding parameter control unit 107 executes the encoding of the broadcasting program data of the recording object received by the TV tuner 101 according to the set encoding parameter (step S103). The CPU 105 executes processing to store the encoded broadcasting program data in the storage device 106 (step S104). The processing of the steps S103 and S104 is repeatedly executed until the recording is completed (NO in step S105).

FIG. 6 shows another example of the constitution of the encoding parameter.

The encoding parameter of FIG. 6 contains a plurality of parameters (encoding parameters for scenes A, B, C, . . . D) corresponding to a plurality of scenes (scenes A, B, C, . . . D) forming the moving picture data of the recording object, respectively. The CPU 105 controls the encoding parameter control unit 107, and sets to the encoding unit 104 the encoding parameter corresponding to the scene which is the present encoding object. Accordingly, the encoding parameter for use is dynamically switched every scene of the encoding object. Therefore, the encoding unit 104 can encode a plurality of scenes (scenes A, B, C, . . . D) forming the moving picture data of the recording object by use of the parameters (parameters for the scenes A, B, C, . . . D) corresponding to these scenes, respectively. Consequently, it is possible to use the encoding parameter suitable for the content of the scene for every scene.

The scene can be detected by using, for example, a value of a detected motion vector, a value of an error component, or the like. Moreover, the encoding parameter may be prepared beforehand for each group of pictures (GOP) instead of each scene, and the encoding parameter for use may be switched for every GOP of the encoding object. Alternatively, the encoding parameter may be switched for every frame, field, macro block, sub-block, object or the like.

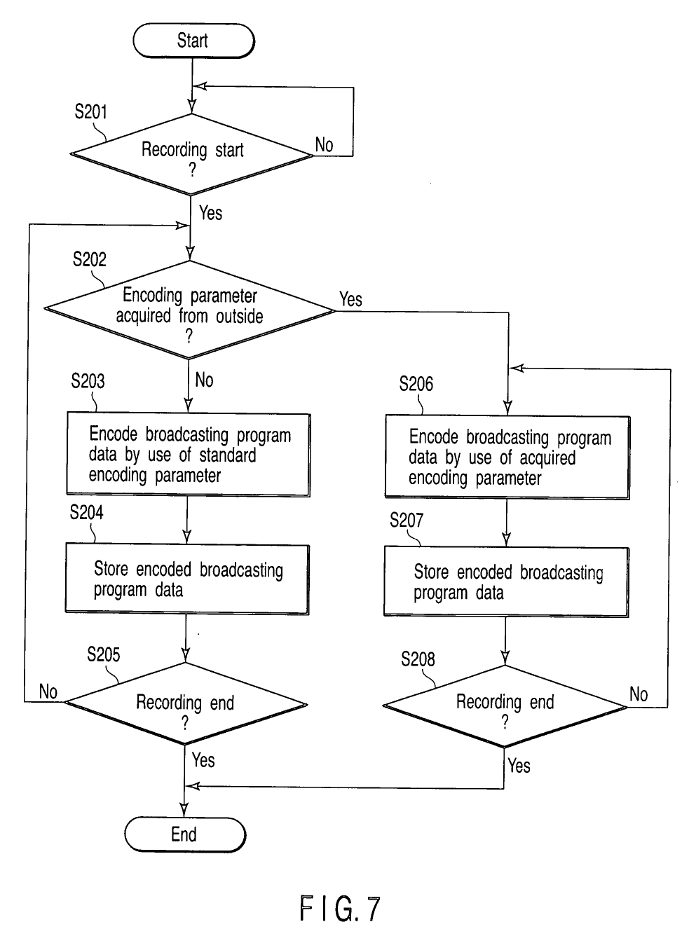

Next, processing to be executed will be described in a case where the encoding parameter cannot be acquired from the outside before the recording of the broadcasting program data is started with reference to a flowchart of FIG. 7.

This situation occurs, for example, in a case where a recording button is operated by the user, when the signal processing apparatus 1 receives and reproduces the broadcasting program data being broadcasted. In this case, the CPU 105 starts the processing to record the broadcasting program data of the recording object, and performs the following processing in this background.

For example, the CPU 105 acquires the category or program name of the broadcasting program data of the recording object from the electronic program table with reference to the electronic program table by use of a key such as a channel number of the broadcasting program data being broadcasted, the present time and the like. The CPU 105 may display the category selection screen W1 of FIG. 4, and allow the user to designate the kind of the broadcasting program data of the recording object. Furthermore, when the received broadcasting data includes attribute information such as the category/program name of the broadcasting program data, the kind of the broadcasting program data of the recording object can be determined from the attribute information. Thereafter, the CPU 105 executes the processing to acquire from the outside the encoding parameter corresponding to the kind of the broadcasting program data of the recording object.

In a period from a time when the recording button is operated until the encoding parameter is acquired from the outside (YES in step S201, NO in step S202), the encoding unit 104 executes the encoding of the broadcasting program data in accordance with the standard encoding parameter preset to the encoding unit 104 (step S203). The CPU 105 executes the processing to store the encoded broadcasting program data in the storage device 106 (step S204).

When the encoding parameter corresponding to the kind of the broadcasting program data being recorded can be acquired from the outside before completing the recording (NO in step S205, YES in step S202), the CPU 105 controls the encoding parameter control unit 107 to set the encoding parameter acquired from the outside to the encoding parameter control unit 107. Accordingly, thereafter the encoding parameter control unit 107 executes the encoding of the broadcasting program data in accordance with the set encoding parameter (step S206). The CPU 105 executes the processing to store the encoded broadcasting program data in the storage device 106 (step S207). The processing of the steps S206 and S207 is repeatedly executed until the recording is completed (NO in step S208).

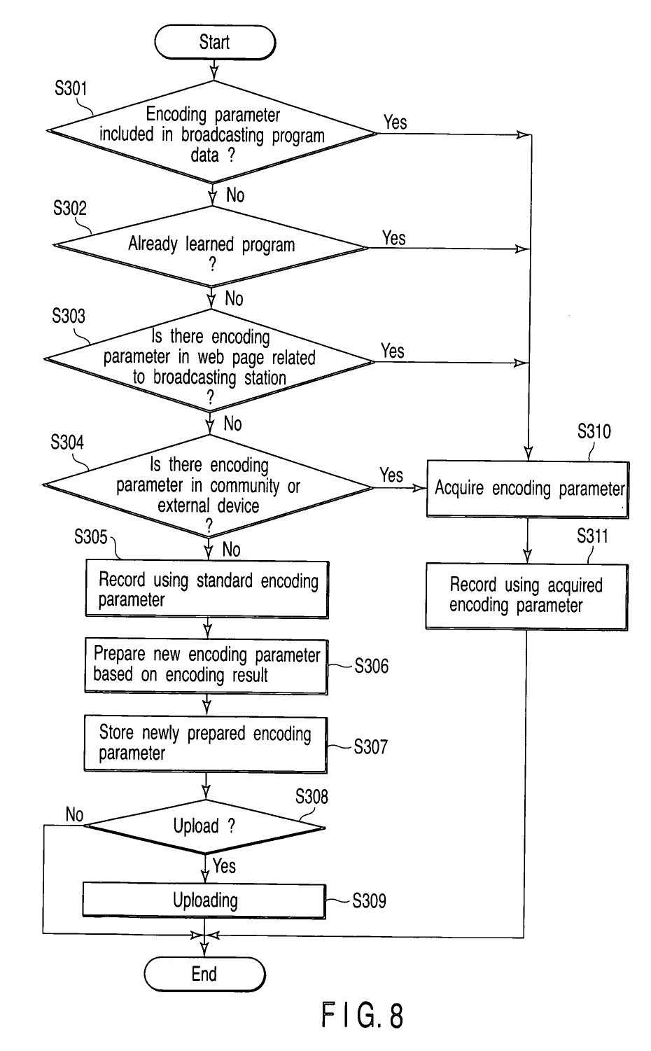

Next, a specific example of a procedure of the recording control processing executed by the CPU 105 will be described with reference to FIG. 8.

First, the CPU 105 determines whether or not the broadcasting data received by the TV tuner 101 includes the encoding parameter corresponding to the kind of the broadcasting program data of the recording object (step S301). If the broadcasting data includes the encoding parameter corresponding to the category of the broadcasting program data of the recording object or the encoding parameter corresponding to the broadcasting program data itself of the recording object (YES in step S301), the CPU 105 acquires the encoding parameter as the encoding parameter corresponding to the kind of the broadcasting program data of the recording object from the broadcasting data (step S310).

If this encoding parameter is not included in the broadcasting data (NO in step S301), the CPU 105 determines whether or not the broadcasting program data of the recording object is already learned broadcasting program data (step S302). The already learned broadcasting program data is broadcasting program data in which the corresponding encoding parameter is already prepared by the learning function. For example, when the broadcasting program data whose corresponding encoding parameter is already prepared by the learning function is broadcasted again, and the rebroadcasted program is recorded again, the rebroadcasted program is determined as the already learned broadcasting program data. If the broadcasting program data of the recording object is the already learned broadcasting program data (YES in step S302), the CPU 105 acquires the encoding parameter already prepared by the learning function as the encoding parameter corresponding to the kind of the broadcasting program data of the recording object from the storage device 106 (step S310).

If the broadcasting program data is not already learned (YES in step S302), the CPU 105 determinates whether or not there is the corresponding encoding parameter in the web page associated with the broadcasting station (step S303). In this step S303, the CPU 105 searches the web page associated with the broadcasting station, that is, the encoding parameter table T1 of the server computer 22 to determine whether or not there is the encoding parameter corresponding to the category of the broadcasting program data of the recording object, or the encoding parameter corresponding to the broadcasting program data itself of the recording object (step S303). If the parameter exists (YES in step S303), the CPU 105 acquires the encoding parameter as the encoding parameter corresponding to the kind of the broadcasting program data of the recording object from the encoding parameter table T1 of the server computer 22 (step S310).

If either of the encoding parameter corresponding to the category of the broadcasting program data of the recording object and the encoding parameter corresponding to the broadcasting program data itself of the recording object does not exist in the encoding parameter table T1 of the server computer 22 (NO in step S303), the CPU 105 determines whether or not there exists the encoding parameter corresponding to the category of the broadcasting program data of the recording object or the encoding parameter corresponding to the broadcasting program data itself of the recording object in the web servers 21, 22 or the external device 110 (step S304). If the parameter exists (YES in step S304), the CPU 105 acquires the encoding parameter as the encoding parameter corresponding to the kind of the broadcasting program data of the recording object from the web servers 21, 22 or the external device 110 (step S310). In addition, in the step S304, it may be determined whether or not there exists the corresponding encoding parameter in the signal processing apparatus 2, the home server 11, the external storage device 1a, the storage device 106 and the like in addition to the web servers 21, 22 and the external device 110.

When it is possible to acquire the encoding parameter corresponding to the kind of the broadcasting program data of the recording object from the outside in the above-described manner, the CPU 105 stores the acquired encoding parameter in the storage device 106, and records the broadcasting program data of the recording object by use of the acquired encoding parameter (step S311). In the step S311, the CPU 105 executes the processing to encode the broadcasting program data of the recording object in accordance with the acquired encoding parameter, and the processing to store the encoded broadcasting program data in the storage device 106.

On the other hand, when the encoding parameter corresponding to the kind of the broadcasting program data of the recording object cannot be acquired from the outside (NO in step S304), the CPU 105 records the broadcasting program data of the recording object by use of the standard encoding parameter (step S305). In the step S305, the CPU 105 executes the processing to encode the broadcasting program data of the recording object in accordance with the standard encoding parameter, and the processing to store the encoded broadcasting program data in the storage device 106.

Thereafter, the CPU 105 prepares a new encoding parameter suitable for the broadcasting program data encoded in accordance with the standard encoding parameter utilizing a technology referred to as two-path encoding or multi-path encoding (step S306). In the step S306, the CPU 105 analyzes the encoded broadcasting program data in accordance with the standard encoding parameter, and prepares a new encoding parameter in accordance with the analysis result. In this case, for example, the CPU 105 analyzes a distribution of encode amounts of the broadcasting program data encoded in accordance with the standard encoding parameter, and prepares the new encoding parameter in such a manner that an optimum encode amount is allocated.

Next, the CPU 105 stores the newly prepared encoding parameter in the storage device 106 (step S307). Moreover, the CPU 105 asks the user, for example, whether or not the newly prepared encoding parameter needs to be published to thereby determine whether or not the newly prepared encoding parameter needs to be uploaded in the web server 21 (step S308). If the newly prepared encoding parameter needs to be uploaded (YES in step S308), the CPU 105 uploads the newly prepared encoding parameter in the web server 21 by use of the network interface 108 (step S309).

It is to be noted that an execution order of the steps S301, S302, S303, and S304 can be arbitrarily changed. It can be set whether or not to execute operations of the steps S306, S307, and S308.

As described above, in the present embodiment, the encoding parameter corresponding to the kind of the broadcasting program data of the recording object is acquired from the outside, and the recording is executed using the encoding parameter. Therefore, the recording can be performed using the latest encoding parameter suitable for the content of the broadcasting program data of the recording object, and the broadcasting program data of any category can be recorded with a sufficiently satisfactory picture quality.

In addition, the encoding parameter acquired from the outside is accumulated in the storage device 106. Therefore, after several types of encoding parameters are stored in the storage device 106, the processing may be first performed to check whether or not there exists the encoding parameter corresponding to the broadcasting program data of the recording object in the storage device 106, and to acquire the corresponding encoding parameter from the outside in a case where the parameter does not exist.

Moreover, it is possible to acquire the encoding parameter corresponding to the kind of the moving picture data even with respect to the moving picture data such as video home system (VHS) data input from the AV input unit 102. In this case, the user may designate the kind of the moving picture data of the recording object by use of the operation screen described with reference to FIG. 4.

Furthermore, when the signal processing apparatus 1 is realized as a personal computer or a device capable of executing various types of software, the encoding unit 104, the encoding parameter control unit 107 and the like can be realized by the software, respectively.

In addition, the moving picture data such as the broadcasting program data may be input into the signal processing apparatus 1 via the I/O controller 109. The moving picture data input via the I/O controller 109 is transferred to the encoding unit 104 via the CPU 105. The moving picture data input from the I/O controller 109 may be transferred to the encoding unit 104 via a direct memory access (DMA) controller or the like without interposing the CPU 105.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A signal processing apparatus comprising:
a determining unit which determines a kind of moving picture data of a recording object;
an acquiring unit which acquires from outside an encoding parameter corresponding to the kind of the moving picture data of the recording object determined by the determining unit;
an encoding unit which executes an encoding process of encoding the moving picture data of the recording object in accordance with the encoding parameter acquired by the acquiring unit; and
a storing unit which stores in a storage medium the moving picture data encoded by the encoding unit.

2. The signal processing apparatus according to claim 1, wherein the encoding process includes a plurality of processing steps of encoding the moving picture data of the recording object; and
the encoding parameter includes a plurality of control values to control the plurality of processing steps, respectively.

3. The signal processing apparatus according to claim 1, wherein the encoding parameter includes a plurality of parameters corresponding to a plurality of scenes forming the moving picture data of the recording object, respectively; and
the encoding unit encodes the plurality of scenes forming the moving picture data of the recording object by use of the plurality of parameters, respectively.

4. The signal processing apparatus according to claim 1, wherein the encoding unit encodes the moving picture data in accordance with a standard encoding parameter stored in a storage device disposed in the signal processing apparatus, when the encoding parameter corresponding to the kind of the moving picture data of the recording object cannot be acquired from the outside.

5. The signal processing apparatus according to claim 4, further comprising a analyzing unit which analyzes the moving picture data encoded according to the standard encoding parameter, and which prepares a new encoding parameter corresponding to the moving picture data encoded in accordance with an analysis result; and
the encoding unit encodes the moving picture data in accordance with the new encoding parameter, when the moving picture data in which the new encoding parameter prepared is recorded again.

6. The signal processing apparatus according to claim 1, further comprising a communication control unit which executes a communication with a server via a network, wherein the acquiring unit acquires the encoding parameter corresponding to the kind of the moving picture data from the server via the network.

7. The signal processing apparatus according to claim 1, further comprising a receiving unit which receives broadcasting data, wherein
the moving picture data of the recording object is broadcasting program data acquired from the broadcasting data received by the receiving unit, and
the determining unit determines a kind of the broadcasting program data of the recording object with reference to electronic program table information on the broadcasting program data of the recording object.

8. The signal processing apparatus according to claim 1, further comprising a receiving unit which receives broadcasting data, wherein
the moving picture data of the recording object is broadcasting program data acquired from the broadcasting data received by the receiving unit, and the broadcasting data includes the encoding parameter corresponding to a kind of the broadcasting program data of the recording object, and
the acquiring unit acquires the encoding parameter corresponding to the kind of the broadcasting program data of the recording object from the broadcasting data received by the receiving unit.

9. The signal processing apparatus according to claim 1, further comprising a display controlling unit which displays an operation screen which allows a user to designate the kind of the moving picture data of the recording object.

10. A recording method of recording moving picture data, comprising:
determining a kind of the moving picture data of a recording object;
acquiring from outside an encoding parameter corresponding to the kind of the moving picture data of the determined recording object;
executing an encoding process of encoding the moving picture data in accordance with the acquired encoding parameter; and
storing the encoded moving picture data in a storage medium.

11. The recording method according to claim 10, wherein the encoding process includes a plurality of processing steps of encoding the moving picture data of the recording object; and
the encoding parameter includes a plurality of control values to control the plurality of processing steps, respectively.

12. The recording method according to claim 10, wherein the encoding parameter includes a plurality of parameters corresponding to a plurality of scenes forming the moving picture data of the recording object, respectively; and
the encoding process includes encoding of the plurality of scenes forming the moving picture data of the recording object by use of the plurality of parameters, respectively.

13. The recording method according to claim 10, further comprising:
encoding the moving picture data in accordance with a standard encoding parameter, when the encoding parameter corresponding to the kind of the moving picture data of the recording object cannot be acquired from the outside;
analyzing the moving picture data encoded in accordance with the standard encoding parameter, and preparing a new encoding parameter corresponding to the moving picture data encoded in accordance with an analysis result; and
encoding the moving picture data in accordance with the new encoding parameter, when the moving picture data in which the new encoding parameter prepared is recorded again.
